(19) United States
(12) Patent Application Publication
(10) Pub. No.: US 2025/0189343 A1
(43) Pub. Date: Jun. 12, 2025

(54) POSITIONING INFORMATION PROCESSING METHOD AND APPARATUS, DEVICE, AND MEDIUM

(71) Applicant: TENCENT TECHNOLOGY (SHENZHEN) COMPANY LIMITED, Shenzhen (CN)

(72) Inventors: Pan JIANG, Shenzhen (CN); Yilong YUAN, Shenzhen (CN); Liang LIN, Shenzhen (CN)

(73) Assignee: TENCENT TECHNOLOGY (SHENZHEN) COMPANY LIMITED, Shenzhen (CN)

(21) Appl. No.: 19/047,793

(22) Filed: Feb. 7, 2025

Related U.S. Application Data
(63) Continuation of application No. PCT/CN2023/127774, filed on Oct. 30, 2023.

(30) Foreign Application Priority Data
Jan. 12, 2023 (CN) 202310072397.4

(51) Int. Cl. G01C 21/00; G01C 21/28; G06T 7/73

(52) U.S. Cl. CPC G01C 21/3848; G01C 21/28; G06T 7/73; G06T 2207/30256

(57) ABSTRACT

A positioning information processing method includes obtaining first positioning information of a target object through dead reckoning based on inertial sensor information collected for the target object; obtaining second positioning information of the target object based on correction and compensation of the first positioning information in a first direction based on visual sensor information collected; obtaining historical positioning information of the target object, and determining a first distance based on the historical positioning information and the first positioning information; obtaining target positioning information of the target object based on performing second correction and compensation on the second positioning information in a second direction based on the first distance; and outputting via a display, a depiction of the target object at a location on a navigation map that is based on the target positioning information.

### CROSS REFERENCE TO RELATED APPLICATIONS

This application is a continuation application of International Application No. PCT/CN2023/127774 filed on Oct. 30, 2023, which claims priority to Chinese patent application No. 202310072397.4, filed with the China National Intellectual Property Administration on Jan. 12, 2023, the disclosures of each being incorporated by reference herein in their entireties.

### FIELD

The disclosure relates to the field of electronic maps, to navigation technology, and to a positioning information processing method and apparatus, device, and medium.

### BACKGROUND

Navigation technology may involve a moving target object that is positioned through measurement of a parameter related to a location of the target object at each moment, and the target object may be correctly, safely, accurately, and economically guided from a start point to a destination along a predetermined route. During navigation, positioning information of the target object may be continuously updated, and accuracy of the positioning information of the target object may also directly related to accuracy of a navigation result. For example, in the field of vehicle navigation, accuracy of positioning information of a vehicle is also directly related to accuracy of a vehicle navigation result.

In a conventional technology, positioning information from a satellite and positioning information obtained through calculation based on inertial sensor information are fused as final positioning information of a target object. However, in a scenario in which the satellite positioning information cannot be obtained, for example, such as when the target object is in a tunnel, accuracy of positioning results for the target object may be low and may result in the waste of a hardware resource configured for supporting positioning of the target object.

### SUMMARY

According to an aspect of the disclosure, a positioning information processing method, performed by a terminal, includes obtaining first positioning information of a target object through dead reckoning based on inertial sensor information collected for the target object; obtaining second positioning information of the target object based on performing first correction and compensation on the first positioning information in a first direction based on visual sensor information collected from an environment in which the target object is located; obtaining historical positioning information of the target object, and determining a first distance based on the historical positioning information and the first positioning information, wherein the historical positioning information is obtained based on performing historical correction and compensation on historically calculated positioning information, and wherein the historically calculated positioning information is obtained through dead reckoning before the first positioning information is obtained through dead reckoning; obtaining target positioning information of the target object based on performing second correction and compensation on the second positioning information in a second direction based on the first distance; and outputting via a display, a depiction of the target object at a location on a navigation map that is based on the target positioning information.

According to an aspect of the disclosure, a positioning information processing apparatus includes, at least one memory configured to store computer program code; and at least one processor configured to read the program code and operate as instructed by the program code, the program code including first positioning code configured to cause at least one of the at least one processor to obtain first positioning information of a target object through dead reckoning based on inertial sensor information collected for the target object; second positioning code configured to cause at least one of the at least one processor to obtain second positioning information of the target object based on performing first correction and compensation on the first positioning information in a first direction based on visual sensor information collected from an environment in which the target object is located; historical positioning code configured to cause at least one of the at least one processor to obtain historical positioning information of the target object, and determine a first distance based on the historical positioning information and the first positioning information, wherein the historical positioning information is obtained based on performing historical correction and compensation on historically calculated positioning information, and wherein the historically calculated positioning information is obtained through dead reckoning before the first positioning information is obtained through dead reckoning; first target positioning code configured to cause at least one of the at least one processor to obtain target positioning information of the target object based on performing second correction and compensation on the second positioning information in a second direction based on the first distance; and display code configured to cause at least one of the at least one processor to output via a display, a depiction of the target object at a location on a navigation map that is based on the target positioning information.

According to an aspect of the disclosure, a non-transitory computer-readable storage media, storing computer code which, when executed by at least one processor, causes the at least one processor to at least obtain first positioning information of a target object through dead reckoning based on inertial sensor information collected for the target object; obtain second positioning information of the target object based on performing first correction and compensation on the first positioning information in a first direction based on visual sensor information collected from an environment in which the target object is located; obtain historical positioning information of the target object, and determine a first distance based on the historical positioning information and the first positioning information, wherein the historical positioning information is obtained based on performing historical correction and compensation on historically calculated positioning information, and wherein the historically calculated positioning information is obtained through dead reckoning before the first positioning information is obtained through dead reckoning; obtain target positioning information of the target object based on performing second correction and compensation on the second positioning information in a second direction based on the first distance; and output via a display, a depiction of the target object at a location on a navigation map that is based on the target positioning information.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of an application environment of a positioning information processing method according to some embodiments.

FIG. 2 is a schematic flowchart of a positioning information processing method according to some embodiments.

FIG. 3 is a schematic diagram of a principle of positioning correction according to some embodiments.

FIG. 4 is a schematic flowchart of a positioning information processing method according to some embodiments.

FIG. 5 is a schematic diagram of an effect of a target vehicle entering a tunnel according to some embodiments.

FIG. 6 is a schematic diagram of an effect of a target vehicle exiting a tunnel according to some embodiments.

FIG. 7 is a schematic flowchart of a positioning information processing method according to some embodiments.

FIG. 8 is a structural block diagram of a positioning information processing apparatus according to some embodiments.

FIG. 9 is a structural block diagram of a positioning information processing apparatus according to some embodiments.

FIG. 10 is a diagram of an internal structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

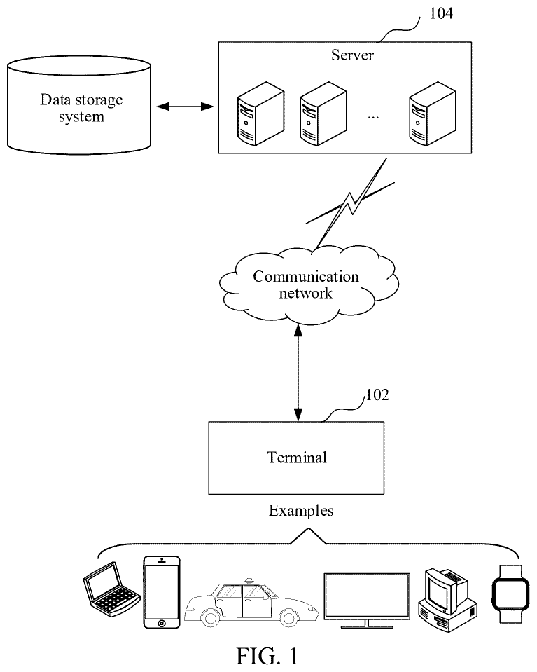

A positioning information processing method provided in some embodiments may be applied to an application environment shown in FIG. 1. A terminal 102 communicates with a server 104 through a network. A data storage system may store data that the server 104 is to process. The data storage system may be integrated on the server 104, or may also be placed on a cloud or another server. The terminal 102 may be, but not limited to, a desktop computer, a notebook computer, a smartphone, a tablet computer, an Internet of Things device, or a portable wearable device. The Internet of Things device may be a smart speaker, a smart television, a smart air conditioner, a smart in-vehicle device, or the like. The portable wearable device may be a smart watch, a smart band, a head-mounted device, or the like. The server 104 may be an independent physical server, or may be a server cluster including a plurality of physical servers or a distributed system, or may be a cloud server providing cloud computing services, such as a cloud service, a cloud database, cloud computing, a cloud function, cloud storage, a network service, cloud communication, a middleware service, a domain name service, a network security service such as cloud security or host security, a content delivery network (CDN), big data, and an artificial intelligence platform. The terminal 102 and the server 104 may be directly or indirectly connected in a wired or wireless communication manner. However, the disclosure is not limited thereto.

The terminal 102 may obtain first positioning information of a target object, the first positioning information being obtained through dead reckoning based on inertial sensor information collected for the target object. The terminal 102 may perform correction on the first positioning information in a first direction based on visual sensor information collected from an environment in which the target object is located, to obtain second positioning information of the target object. The terminal 102 may obtain historical positioning information of the target object, and determine a first distance based on the historical positioning information and the first positioning information, the historical positioning information being obtained after correction and compensation are performed on historically calculated positioning information, and the historically calculated positioning information being obtained through dead reckoning before the first positioning information is obtained through dead reckoning. The terminal 102 may perform correction on the second positioning information in a second direction based on the first distance, to obtain target positioning information of the target object after correction and compensation.

The terminal 102 may render and display a location of the target object based on the target positioning information obtained after correction and compensation. The terminal 102 may further transmit the target positioning information obtained after correction and compensation to the server 104, and the server 104 performs corresponding positioning data processing on the target positioning information. However, the disclosure is not limited thereto. An application scenario in FIG. 1 is merely an example.

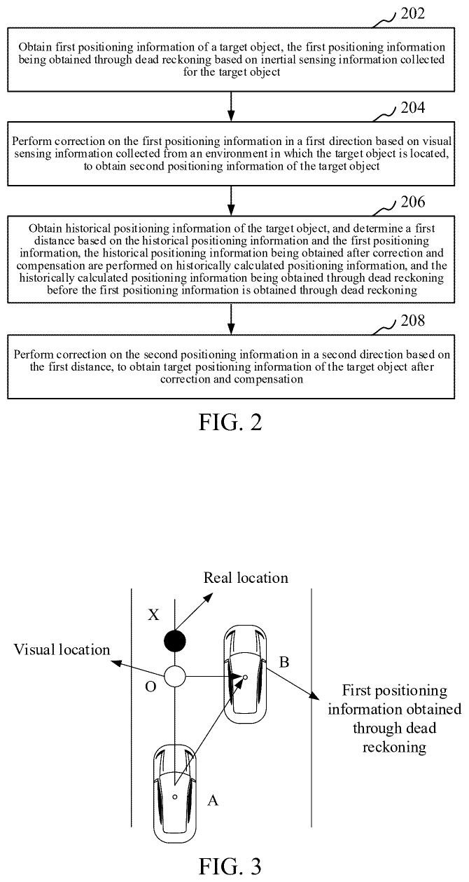

In some embodiments, as shown in FIG. 2, a positioning information processing method is provided. An example in which the method is applied to the terminal 102 in FIG. 1 is used in some embodiments for description, and the following operations are included.

Operation 202: Obtain first positioning information of a target object, the first positioning information being obtained through dead reckoning based on inertial sensor information collected for the target object.

The object is an entity with a mobile function, and the terminal may be deployed on the object. For example, the object may be a vehicle. If the object is a vehicle, the terminal may be deployed on the vehicle. A current positioning moment is a moment at which the target object is currently positioned. The inertial sensor information is information collected by using an inertial sensor arranged on the target object. The inertial sensor includes a gyroscope and an accelerometer. The first positioning information is positioning information obtained through dead reckoning based on the inertial sensor information of the target object. Dead reckoning is a method of calculating positioning information of the target object at a next moment based on the collected inertial sensor information when positioning information of the target object at a current moment is known during navigation of the target object, to implement positioning of the target object.

For example, the terminal may perform information collection by using the inertial sensor arranged on the target object, to obtain the inertial sensor information. Further, the terminal may perform dead reckoning based on the inertial sensor information of the target object, to obtain the first positioning information corresponding to the target object.

In some embodiments, as shown in FIG. 3, the target object is a target vehicle. The terminal may be arranged on the target vehicle, and a vehicle inertial sensor is also arranged on the target vehicle. The terminal may communicate with the vehicle inertial sensor, and may perform information collection by using the vehicle inertial sensor, to obtain inertial sensor information of the target vehicle. Positioning information corresponding to a point B is the first positioning information obtained through dead reckoning based on the inertial sensor information of the target vehicle.

Operation 204: Perform correction on the first positioning information in a first direction based on visual sensor information collected from an environment in which the target object is located, to obtain second positioning information of the target object.

The visual sensor information is information collected by using a vision sensor arranged on the target object from the environment in which the target object is located. The first direction is a direction perpendicular to a forward direction of the target object. The first direction is perpendicular to a direction of a road on which the target object is located, in other words, the first direction is a transverse direction. The second positioning information is positioning information obtained through correction performed on the first positioning information in the first direction based on the visual sensor information of the target object.

For example, the terminal may perform information collection by using the vision sensor arranged on the target object, to obtain the visual sensor information. Further, the terminal may perform compensation and correction on the first positioning information in the first direction based on the visual sensor information of the target object, to obtain the second positioning information corresponding to the target object. The terminal may perform transverse compensation and correction on the first positioning information based on the visual sensor information, to obtain the second positioning information corresponding to the target object.

In some embodiments, still referring to FIG. 3, the terminal may perform correction on the first positioning information, for example, the positioning information corresponding to the point B, in the first direction (for example, a BO direction) based on visual sensor information of the target vehicle, to obtain second positioning information corresponding to the target vehicle, for example, positioning information corresponding to a point O.

In some embodiments, visual positioning location information corresponding to the target object is determined based on the visual sensor information of the target object, and correction is performed on the first positioning information in the first direction based on the visual positioning location information, to obtain the second positioning information corresponding to the target object. Still referring to FIG. 3, a location point corresponding to the visual positioning location information is also the point O.

In some embodiments, in a case that a global positioning system (GPS) fails, in other words, the terminal cannot receive satellite positioning information of the target object, the terminal may directly perform correction on the first positioning information in the first direction based on the visual sensor information of the target object, to obtain the second positioning information corresponding to the target object.

Operation 206: Obtain historical positioning information of the target object, and determine a first distance based on the historical positioning information and the first positioning information, the historical positioning information being obtained after correction and compensation are performed on historically calculated positioning information, and the historically calculated positioning information being obtained through dead reckoning before the first positioning information is obtained through dead reckoning.

For example, the terminal may obtain the historical positioning information of the target object, and determine the first distance between the historical positioning information and the first positioning information based on a location corresponding to the historical positioning information of the target object and a location corresponding to the first positioning information. The first distance is a distance between a location point corresponding to the historical positioning information and a location point corresponding to the first positioning information.

In some embodiments, still referring to FIG. 3, the terminal may obtain the historical positioning information (for example, positioning information corresponding to a point A) after performing correction and compensation on the historically calculated positioning information. Further, the terminal may determine the first distance (for example, AB) between the location point (for example, the point A) corresponding to the historical positioning information and the location point (for example, the point B) corresponding to the first positioning information. The historically calculated positioning information is obtained through dead reckoning for the target vehicle before the first positioning information is obtained through dead reckoning.

In some embodiments, the foregoing first positioning information is positioning information calculated at the current positioning moment. The terminal may perform correction on the first positioning information in the first direction based on the visual sensor information of the target object, to obtain the second positioning information corresponding to the target object at the current positioning moment, and determine the first distance between the historical positioning information and the first positioning information. Further, the terminal may perform correction on the second positioning information in a second direction based on the first distance, to obtain target positioning information corresponding to the current positioning moment after correction and compensation. The terminal may perform correction and compensation for each positioning moment.

Operation 208: Perform correction on the second positioning information in the second direction based on the first distance, to obtain the target positioning information of the target object after correction and compensation.

The second direction is a direction in the forward direction of the target object. The second direction is consistent with a direction of a road on which the target object is located when moving forward, in other words, the second direction is a longitudinal direction. The target positioning information is configured for representing a final positioning result of the target object.

For example, the terminal may perform correction on the second positioning information in the second direction based on the first distance between the historical positioning information and the first positioning information, to obtain the target positioning information of the target object after correction and compensation. The terminal may perform longitudinal correction on the second positioning information based on the first distance, to obtain the target positioning information after correction and compensation. Compared with the first positioning information, the target positioning information is obtained through transverse correction and longitudinal correction.

In some embodiments, still referring to FIG. 3, the terminal may perform correction on a location point (for example, the point O) corresponding to the second positioning information in the second direction (for example, an OX direction) based on the first distance (for example, AB) between the location point corresponding to the historical positioning information and the location point (for example, the point B) corresponding to the first positioning information, to obtain the target positioning information after correction and compensation. If a heading of the target vehicle does not deviate, a location corresponding to a point X is a real location of the target vehicle. In other words, the closer a positioning point corresponding to the target positioning information after correction and compensation in some embodiments is to the point X, the better. The closer the positioning point corresponding to the target positioning information is to the point X, the higher positioning accuracy.

In some embodiments, the terminal may determine a second distance based on the historical positioning information and the second positioning information, and perform correction on the second positioning information in the second direction based on the first distance and the second distance, to obtain the target positioning information of the target object after correction and compensation.

In the foregoing positioning information processing method, the first positioning information of the target object is obtained, the first positioning information being obtained through dead reckoning based on the inertial sensor information collected for the target object; correction is performed on the first positioning information in the first direction based on the visual sensor information collected from the environment in which the target object is located, to obtain the second positioning information of the target object; the historical positioning information of the target object is obtained, and the first distance is determined based on the historical positioning information and the first positioning information, the historical positioning information being obtained after correction and compensation are performed on the historically calculated positioning information, and the historically calculated positioning information being obtained through dead reckoning before the first positioning information is obtained through dead reckoning; and correction is performed on the second positioning information in the second direction based on the first distance. This is equivalent to that, without depending on satellite positioning, both compensation and correction in the first direction and compensation and correction in the second direction are performed on positioning information obtained through dead reckoning. Therefore, the target positioning information finally obtained after correction and compensation is more accurate, and positioning accuracy is improved, so that a waste of a hardware resource configured for supporting positioning of the target object can be avoided.

In some embodiments, the performing correction on the second positioning information in the second direction based on the first distance, to obtain the target positioning information of the target object after correction and compensation includes: determining the second distance based on the historical positioning information and the second positioning information; and performing correction on the second positioning information in the second direction based on a difference between the first distance and the second distance, to obtain the target positioning information of the target object after correction and compensation.

The second distance is a distance between the location point corresponding to the historical positioning information and the location point corresponding to the second positioning information.

For example, the terminal may determine the second distance based on the location point corresponding to the historical positioning information and the location point corresponding to the second positioning information. The terminal may perform correction on the second positioning information in the second direction based on the difference between the first distance and the second distance, to obtain the target positioning information of the target object after correction and compensation.

In some embodiments, still referring to FIG. 3, the difference between the first distance and the second distance may be determined by using the following formula:

$$O X = \sqrt{{AO}^{2} + {OB}^{2}} - A O$$

\sqrt{AO²+OB²} is the first distance AB between the location point (for example, the point A) corresponding to the historical positioning information and the location point (for example, the point B) corresponding to the first positioning information, and AO is the second distance between the location point corresponding to the historical positioning information and the location point (for example, the point O) corresponding to the second positioning information.

In some embodiments, the terminal may perform correction on location information in the second positioning information in the second direction based on the difference between the first distance and the second distance, to obtain the target positioning information including location information obtained after correction and compensation.

In some embodiments, correction is performed on the second positioning information in the second direction based on the difference between the first distance and the second distance. In this way, accuracy of the obtained target positioning information can be improved, so that accuracy of the positioning result of the target object is further improved, and the waste of the hardware resource configured for supporting positioning of the target object can be further avoided.

In some embodiments, the second positioning information includes transverse positioning information and longitudinal positioning information; and the performing correction on the second positioning information in the second direction based on a difference between the first distance and the second distance, to obtain the target positioning information of the target object after correction and compensation includes: performing longitudinal correction on the longitudinal positioning information based on the difference between the first distance and the second distance, to obtain longitudinal corrected positioning information; and determining, based on the transverse positioning information and the longitudinal corrected positioning information, the target positioning information after correction and compensation.

The transverse positioning information is positioning information about a direction perpendicular to the forward direction of the target object in the second positioning information. The longitudinal positioning information is positioning information about a direction the same as the forward direction of the target object in the second positioning information. The longitudinal corrected positioning information is positioning information that is obtained through longitudinal correction performed on the longitudinal positioning information based on the difference between the first distance and the second distance and that belongs to a longitudinal dimension.

For example, the terminal may perform longitudinal correction on the longitudinal positioning information based on the difference between the first distance and the second distance, to obtain the longitudinal corrected positioning information, and determine, based on the transverse positioning information and the longitudinal corrected positioning information, the target positioning information after correction and compensation The target positioning information after correction and compensation includes the transverse positioning information and the longitudinal corrected positioning information.

In some embodiments, the transverse positioning information includes transverse location information, the longitudinal positioning information includes longitudinal location information, the longitudinal corrected positioning information includes longitudinal corrected location information, and the target positioning information includes target location information; the performing longitudinal correction on the longitudinal positioning information based on the difference between the first distance and the second distance, to obtain the longitudinal corrected positioning information includes: performing longitudinal location correction on the longitudinal location information based on the difference between the first distance and the second distance, to obtain the longitudinal corrected location information; and the determining, based on the transverse positioning information and the longitudinal corrected positioning information, the target positioning information after correction and compensation includes: determining, based on the transverse location information and the longitudinal corrected location information, the target location information after location correction and compensation.

In some embodiments, the transverse positioning information includes second transverse location information, the longitudinal positioning information includes second longitudinal location information, and the longitudinal corrected positioning information includes longitudinal corrected location information. The terminal may perform longitudinal correction on the second longitudinal location information based on the difference between the first distance and the second distance, to obtain the longitudinal corrected location information, and determine, based on the second transverse location information and the longitudinal corrected location information, the target positioning information after correction and compensation. The longitudinal corrected location information is location information that is obtained through longitudinal correction performed on the second longitudinal location information based on the difference between the first distance and the second distance and that belongs to a longitudinal dimension. The target positioning information after correction and compensation includes the second transverse location information and the longitudinal corrected location information. In some embodiments, longitudinal location correction is performed on the longitudinal location information based on the difference between the first distance and the second distance, to obtain the longitudinal corrected location information. The target location information after location correction and compensation is determined based on the transverse location information and the longitudinal corrected location information. In this way, accuracy of the target location information of the target object can be improved, so that the waste of the hardware resource configured for supporting positioning of the target object can be further avoided.

In some embodiments, longitudinal correction is performed on the longitudinal positioning information based on the difference between the first distance and the second distance. Further, the target positioning information after correction and compensation is determined based on the transverse positioning information and the longitudinal corrected positioning information obtained after correction. In this way, accuracy of the obtained target positioning information can be further improved, so that accuracy of the positioning result of the target object is further improved, and the waste of the hardware resource configured for supporting positioning of the target object can be further avoided.

In some embodiments, the first positioning information is positioning information obtained through dead reckoning at the current positioning moment within a current compensation period; the determining a first distance based on the historical positioning information and the first positioning information includes: determining a distance between the first positioning information obtained through dead reckoning at the current positioning moment and the historical positioning information, to obtain the first distance corresponding to the current positioning moment, where the historical positioning information is obtained after correction and compensation are performed on the target object within a previous compensation period of the current compensation period; and the performing correction on the second positioning information in the second direction based on the first distance, to obtain the target positioning information of the target object after correction and compensation includes: determining a compensation sub-error corresponding to the current positioning moment based on the first distance corresponding to the current positioning moment; performing, when a compensation sub-error corresponding to each of positioning moments within the current compensation period is determined, smoothing processing on the compensation sub-error corresponding to each of the positioning moments within the current compensation period, to obtain a target compensation error corresponding to the current compensation period; determining a target positioning moment from the positioning moments within the current compensation period; and performing, based on the target compensation error, correction on second positioning information corresponding to the target positioning moment in the second direction, to obtain the target positioning information of the target object within the current compensation period.

The current compensation period is a period in which correction and compensation are currently performed. The current compensation period includes a plurality of positioning moments. The positioning moment is a moment at which positioning information of the target object is obtained, and the current positioning moment is a moment at which the positioning information of the target object is currently obtained. The compensation sub-error is a compensation error corresponding to each of the positioning moments within the current compensation period. The target compensation error is a compensation error obtained through smoothing processing performed on the compensation sub-error corresponding to each of the positioning moments within the current compensation period.

For example, the terminal may determine the distance between the first positioning information obtained through dead reckoning at the current positioning moment and the historical positioning information, to obtain the first distance corresponding to the current positioning moment. The terminal may determine a compensation sub-error corresponding to the current positioning moment based on the first distance corresponding to the current positioning moment, and store the compensation sub-error. Further, when the compensation sub-error corresponding to each of the positioning moments within the current compensation period is determined, the terminal may perform smoothing processing on the compensation sub-error corresponding to each of the positioning moments within the current compensation period, to obtain the target compensation error corresponding to the current compensation period; determine the target positioning moment from the positioning moments within the current compensation period; and perform, based on the target compensation error, correction on the second positioning information corresponding to the target positioning moment in the second direction, to obtain the target positioning information corresponding to the current compensation period. The target positioning moment may be one of the positioning moments within the current compensation period.

In some embodiments, visual sensor information corresponding to each of the positioning moments may fluctuate. Therefore, the compensation sub-error corresponding to each of the positioning moments may also fluctuate. Through smoothing processing performed on the compensation sub-error corresponding to each of the positioning moments within the current compensation period, the target compensation error corresponding to the current compensation period may be obtained, thereby improving accuracy of the obtained compensation error. Further, based on the accurate target compensation error, correction is performed on the second positioning information corresponding to the target positioning moment in the second direction, to obtain the target positioning information corresponding to the current compensation period. In this way, accuracy of the obtained target positioning information can be further improved, so that accuracy of the positioning result of the target object is further improved, and the waste of the hardware resource configured for supporting positioning of the target object can be further avoided.

In some embodiments, the method further includes: in a case that it is determined, based on imaging of a lane line in the visual sensor information, that the visual sensor information is available, performing the operation of performing correction on the first positioning information in a first direction based on visual sensor information collected from an environment in which the target object is located, to obtain second positioning information of the target object, and performing subsequent operations.

For example, the terminal may determine whether the visual sensor information collected by the vision sensor is available. In a case that it is determined, based on the imaging of the lane line in the visual sensor information, that the visual sensor information is available, the terminal may perform correction on the first positioning information in the first direction based on the visual sensor information of the target object, to obtain the second positioning information corresponding to the target object, and determine the distance between the historical positioning information and the first positioning information. Further, the terminal may perform correction on the second positioning information in the second direction based on the distance, to obtain the target positioning information after correction and compensation.

For example, if the target object is the target vehicle, in a scenario in which navigation positioning is performed for the target vehicle, that the visual sensor information is available means that the lane line collected by the vision sensor is clear and complete.

In some embodiments, through determining that the visual sensor information is available, a corresponding manner of determining the target positioning information of the target object is selected. In this way, accuracy of the obtained target positioning information can be further improved, so that accuracy of the positioning result of the target object is further improved, and the waste of the hardware resource configured for supporting positioning of the target object can be further avoided.

In some embodiments, the method further includes: in a case that it is determined, based on imaging of a lane line in the visual sensor information, that the visual sensor information is unavailable, using the first positioning information as the target positioning information of the target object.

For example, in a case that it is determined, based on the imaging of the lane line in the visual sensor information, that the visual sensor information is unavailable, the terminal may directly use the first positioning information as the target positioning information of the target object. In a case that the visual sensor information is unavailable, to avoid a mistake in correction and compensation, correction and compensation may not be performed on the first positioning information based on the visual sensor information, and instead, the first positioning information may be directly used as the target positioning information of the target object.

For example, that the visual sensor information is unavailable means that the lane line collected by the vision sensor is blurred or incomplete.

In some embodiments, through determining that the visual sensor information is unavailable, a corresponding manner of determining the target positioning information of the target object is selected. In this way, accuracy of the obtained target positioning information can be further improved, so that accuracy of the positioning result of the target object is further improved, and the waste of the hardware resource configured for supporting positioning of the target object can be further avoided.

In some embodiments, the performing correction on the first positioning information in a first direction based on visual sensor information collected from an environment in which the target object is located, to obtain second positioning information of the target object includes: obtaining the visual sensor information collected from the environment in which the target object is located, determining, based on the visual sensor information, an intercept of the lane line indicated by the target object and the visual sensor information, and determining visual positioning location information of the target object based on the intercept; determining a compensation error based on the visual positioning location information and the first positioning information; and performing correction on the first positioning information in the first direction based on the compensation error, to obtain the second positioning information of the target object.

The visual positioning location information is location information determined through positioning based on the intercept of the target object. The compensation error is information configured for correction and compensation performed on the first positioning information of the target object.

For example, the visual sensor information includes information about the intercept of the lane line. The terminal may obtain the visual sensor information collected from the environment in which the target object is located, determine, based on the visual sensor information, the intercept of the lane line indicated by the target object and the visual sensor information, and determine the visual positioning location information of the target object based on the intercept. The terminal may determine the visual positioning location information based on the intercept of the lane line indicated by the target object and the visual sensor information, the location point corresponding to the historical positioning information, and the location point corresponding to the first positioning information. In other words, the location point corresponding to the visual positioning location information may be determined. Further, the terminal may determine the compensation error based on the visual positioning location information and the first positioning information, and perform correction on the first positioning information in the first direction based on the compensation error, to obtain the second positioning information of the target object.

In some embodiments, the first positioning information includes location information, the second positioning information includes location information, and the compensation error includes a location error. The terminal may determine the location error based on a location difference between the location point corresponding to the visual positioning location information and a location point corresponding to the location information included in the first positioning information. The terminal may perform, based on the location error, location correction on the location information included in the first positioning information in the first direction, to obtain location information of the target object. The location error is an error that is configured for correction and compensation performed on the location information in the first positioning information and that belongs to a location dimension.

In some embodiments, the intercept of the lane line indicated by the target object and the visual sensor information is determined based on the visual sensor information, and the visual positioning location information of the target object is determined. In this way, accuracy of the visual positioning location information can be improved. The compensation error is determined based on the accurate visual positioning location information and the first positioning information. In this way, accuracy of the obtained compensation error can be improved. Further, correction is performed on the first positioning information in the first direction based on the accurate compensation error, to obtain the second positioning information corresponding to the target object. In this way, accuracy of the second positioning information can be improved, and the waste of the hardware resource configured for supporting positioning of the target object can be further avoided.

In some embodiments, the first positioning information includes location information and status information, the second positioning information includes location information and status information, and the compensation error includes a location error and a status error; and the performing correction on the first positioning information in the first direction based on the compensation error, to obtain the second positioning information of the target object includes: performing, based on the location error, location correction on the location information in the first direction, to obtain location information of the target object; and performing, based on the status error, status correction on the status information, to obtain status information corresponding to the target object.

The status error is an error that is configured for correction and compensation performed on the status information in the first positioning information and that belongs to a status dimension.

For example, the terminal may perform, based on the location error, location correction on the location information belonging to the location dimension in the first positioning information in the first direction, to obtain the location information of the target object. The terminal may perform, based on the status error, status correction on the status information belonging to the status dimension in the first positioning information, to obtain the status information of the target object.

In some embodiments, location correction is performed on the location information in the first direction based on the location error, to obtain the location information of the target object. Status correction is performed on the status information based on the status error, to obtain the status information of the target object. In this way, accuracy of the second positioning information can be further improved, and the waste of the hardware resource configured for supporting positioning of the target object can be further avoided.

In some embodiments, the determining a compensation error based on the visual positioning location information and the first positioning information includes: determining the location error based on a location difference between the visual positioning location information and the location information; and performing error solving on a pre-constructed positioning error equation based on the location error, to obtain the status error.

The positioning error equation is a mathematical equation pre-constructed based on a location error and each status error that are to be solved for. In other words, the location error and the status error in the positioning error equation are unknown quantities.

For example, the terminal may determine the location error based on the location difference between the visual positioning location information and the location information. After determining the location error based on the location difference between the visual positioning location information and the location information, the terminal may substitute the location error into the positioning error equation to perform error solving, to solve for each status error.

In some embodiments, the status error includes at least one of a platform misalignment angle error, a velocity error, a dead reckoning error, a gyro bias, an accelerometer bias, an installation error angle residual, a wheel speed sensor scale factor error, or a time delay of transmission from a wheel speed sensor to an inertial sensor, the inertial sensor is arranged on the target object, and the inertial sensor information of the target object is collected by using the inertial sensor. In this way, a plurality of status errors are provided, and the second positioning information is determined based on the location error and the plurality of status errors. In this way, accuracy of the second positioning information can be further improved.

In some embodiments, the positioning error equation is a system of positioning error equations, the system of positioning error equations includes a status equation and a measuring equation, and the performing error solving on a pre-constructed positioning error equation based on the location error, to obtain the status error includes: performing error solving on the pre-constructed system of positioning error equations based on the location error, to obtain the status error. In some embodiments, error solving is performed on the system of positioning error equations, to obtain the status error. In this way, accuracy of the status error can be improved, so that the waste of the hardware resource configured for supporting positioning of the target object can be further avoided.

In some embodiments, the positioning error equation may be a system of positioning error equations, and the system of positioning error equations includes a status equation and a measuring equation. The terminal may perform error solving based on the location error by using the following positioning error equation, to obtain each status error:

$$\{ \begin{matrix}\dot{x} = {F}_{SINS / D R} x \\ z = {H}_{SINS / D R} x\end{matrix} ,$$

where x=[(φ)^{T} (δvⁿ)^{T} (δp)^{T} (δp_{DR})⁷ (ε^{b})^{T} (∇^{b})^{T} (δα)^{T} δK_{OD} τ_{OD}]^{T} represents a status vector, \dot{x} represents a result of derivation performed on x, F_{SINS/DR} is a status transition matrix of a system, and \dot{x}=F_{SINS/DR}x, for example, is the status equation. H_{SINS/DR} represents a measuring matrix of the system, and z=H_{SINS/DR}x, for example, is the measuring equation, where z=\tilde{p}_{SINS}−\tilde{p}_{DR}=(p_{SINS}+δp_{SINS})−(p_{DR}+δp_{DR}+M_{Dpv}v_{OD}ⁿτ_{OD})=δp_{SINS}−δp_{DR}−M_{Dpk}τ_{OD}, \tilde{p}_{SINS} represents location information obtained through dead reckoning based on a strapdown inertial navigation system (SINS), and \tilde{p}_{DR} represents location information obtained through dead reckoning based on a dead reckoning (DR) system. p_{SINS} represents a real part of the location information in \tilde{p}_{SINS}, δ is configured for representing an error, δp_{SINS} represents an error in \tilde{p}_{SINS}, p_{DR} represents a real part of the location information in \tilde{p}_{DR}, and δp_{DR}+M_{Dpv}v_{OD}ⁿτ_{OD} represents an error in \tilde{p}_{DR}. M_{Dpv} represents a relationship matrix between a corresponding location calculated through DR and a velocity, v_{OD}ⁿ represents a velocity calculated through DR, and τ_{OD} represents a time delay of transmission from the wheel speed sensor to the inertial sensor.

The status transition matrix of the system is:

$${F}_{\frac{SINS}{D R}} = [ \begin{matrix}\begin{matrix}{M}_{aa} & {M}_{av} & {M}_{ap} & {0}_{3 \times 3} & - {C}_{b}^{n} & {0}_{3 \times 3} & {0}_{3 \times 2} & {0}_{3 \times 1} & {0}_{3 \times 1} \\ {M}_{va} & {M}_{vv} & {M}_{vp} & {0}_{3 \times 3} & {0}_{3 \times 3} & {C}_{b}^{n} & {0}_{3 \times 2} & {0}_{3 \times 1} & {0}_{3 \times 1} \\ {0}_{3 \times 3} & {M}_{pv} & {M}_{pp} & {0}_{3 \times 3} & {0}_{3 \times 3} & {0}_{3 \times 3} & {0}_{3 \times 2} & {0}_{3 \times 1} & {0}_{3 \times 1} \\ {M}_{Dpa} & {0}_{3 \times 3} & {0}_{3 \times 3} & {M}_{Dpp} & {0}_{3 \times 3} & {0}_{3 \times 3} & {M}_{Dpi} & {M}_{Dpk} & {0}_{3 \times 1}\end{matrix} \\ {0}_{10 \times 22}\end{matrix} ] .$$

The measuring matrix of the system is: H_{SINS/DR}=[0_{3×3} 0_{3×3} I_{3×3}−I_{3×3} 0_{3×3} 0_{3×3} 0_{3×2} 0_{3×1}−M_{Dpk}].

φ=[φ_{E} φ_{N} φ_{U}]^{T} represents a platform misalignment angle error, where φ_{E}, φ_{N}, and φ_{U} respectively represent platform misalignment angle errors in east-north-up three directions in an east-north-up coordinate system. δvⁿ=[δv_{E}ⁿ δv_{N}ⁿ δv_{U}ⁿ]^{T} represents a velocity error, where δv_{E}ⁿ, δv_{N}ⁿ, and δv_{U}ⁿ respectively represent velocity errors in the east-north-up three directions in the east-north-up coordinate system. δp=[δL δλ δλ]^{T} represents a location error, where δL, δλ, and δλ respectively represent error longitude, error latitude, and a height error. δp_{DR} represents a dead reckoning error, and ε^{b}=[εₓ^{b} ε_{y}^{b} ε_{z}^{b}]^{T} represents a gyro bias, where εₓ^{b}, ε_{y}^{b}, and ε_{z}^{b} respectively represent gyro biases in directions in a carrier coordinate system. ∇^{b}=[∇ₓ^{b} ∇_{y}^{b} ∇_{z}^{b}]^{T} represents an accelerometer bias, where ∇ₓ^{b}. ∇_{y}^{b}, and ∇_{z}^{b} respectively represent accelerometer biases in the directions in the carrier coordinate system.

$$δα = [ \begin{matrix}{δα}_{θ} \\ {δα}_{ψ}\end{matrix} ]$$

represents an installation error angle residual, where α_{θ} represents a real pitch angle, α_{ψ} represents a real heading angle, δα_{θ} represents a pitch angle error, and δα_{ψ} represents a heading angle error. δK_{OD} represents a wheel speed sensor scale factor error. Mₐₐ represents an attitude relationship matrix, Mₐᵥ represents a relationship matrix between an attitude and a velocity, Mₐₚ represents a relationship matrix between an attitude and a location, Mᵥₐ represents a relationship matrix between a velocity and an attitude, Mᵥᵥ represents a velocity relationship matrix, Mᵥₚ represents a relationship matrix between a velocity and a location, Mₚᵥ represents a relationship matrix between a location and a velocity, Mₚₚ represents a location relationship matrix, M_{Dpa} represents a relationship matrix between a corresponding location calculated through DR and an attitude, M_{Dpp} represents a relationship matrix between corresponding locations calculated through DR, M_{Dpi} represents a relationship matrix between a corresponding location calculated through DR and a time delay, M_{Dpk} represents a relationship matrix between a corresponding location calculated through DR and a wheel speed sensor scale factor error, C_{b}ⁿ represents a real attitude rotation matrix from a b system (the carrier coordinate system) to an n system (the east-north-up coordinate system), and I represents a unit matrix.

The foregoing relationship matrices each are determined based on at least one unknown quantity (the location error and the status error) in the status vector. The foregoing positioning error equations each are formed by each unknown quantity. After the location error is determined based on the location difference between the visual positioning location information and the location information included in the first positioning information, the location error is substituted into the foregoing positioning error equation, to perform error solving on the positioning error equation, to obtain the status error.

In some embodiments, the first positioning information obtained through calculation based on DR includes calculated velocity information in the n system. The velocity information may be represented by using the following formula:

$${\tilde{v}}_{OD}^{n} = {\tilde{C}}_{b}^{n} [ \begin{matrix}sin cos \\ cos cos \\ sin\end{matrix} ] {\tilde{v}}_{OD} = [ I - ( φ \times ) ] {C}_{b}^{n} [ \begin{matrix}sin ( {α}_{ψ} + {δα}_{ψ} ) cos ( {α}_{θ} + {δα}_{θ} ) \\ cos ( {α}_{ψ} + {δα}_{ψ} ) cos ( {α}_{θ} + {δα}_{θ} ) \\ sin ( {α}_{θ} + {δα}_{θ} )\end{matrix} ] \cdot ( 1 + δ {K}_{OD} ) {v}_{OD} \approx {v}_{O D}^{n} + {v}_{O D}^{n} \times φ + {v}_{O D} {C}_{b}^{n} {M}_{α} δα + {v}_{O D}^{n} δ {K}_{O D}$$

$${M}_{α} = [ \begin{matrix}- sin {α}_{ψ} sin {α}_{θ} & cos {α}_{ψ} cos {α}_{θ} \\ - cos {α}_{ψ} sin {α}_{θ} & - sin {α}_{ψ} cos {α}_{θ} \\ cos {α}_{θ} & 0\end{matrix} ] .$$

\tilde{v}_{OD}ⁿ represents the calculated velocity information in the n system, \tilde{v}_{OD} represents calculated velocity information of the system, and \tilde{C}_{b}ⁿ represents an attitude rotation matrix obtained through calculation from the b system to the n system. [symbol] represents a pitch angle obtained through calculation, [symbol] represents a heading angle obtained through calculation, v_{OD} represents real velocity information of the system, v_{OD}ⁿ represents real velocity information in the n system, and v_{OD}ⁿ×φ+v_{OD}C_{b}ⁿM_{α}δα+v_{OD}ⁿδK_{OD} represents a velocity error existing in \tilde{v}_{OD}ⁿ.

It may be learned from the foregoing derivation process for the calculated velocity information in the n system that, the velocity error obtained through DR calculation mainly includes three aspects: respectively an attitude error (for example, a pitch angle error and a heading angle error), a scale factor error of the wheel speed sensor, and an installation angle error. Some embodiments start with a cause of generation of the attitude error, and correction is performed, based on the visual sensor information, on the first positioning information obtained through dead reckoning. In this way, accuracy of the positioning result of the target object can be further improved. The cause of the generation of the attitude error is that there is a deviation in a heading of the target object, resulting in an error in velocity decomposition, thereby generating the location error through integration.

In some embodiments, the location error is determined based on the location difference between the visual positioning location information and the location information. In this way, accuracy of the location error can be improved. Error solving is performed on the pre-constructed positioning error equation based on the location error, to obtain the status error. In this way, accuracy of the status error can be improved, so that accuracy of the second positioning information can be further improved with provision of the accurate location error and status error, and the waste of the hardware resource configured for supporting positioning of the target object can be further avoided.

In some embodiments, the location information included in the first positioning information includes transverse location information and longitudinal location information; and the performing, based on the location error, location correction on the location information included in the first positioning information in the first direction, to obtain the location information in the second positioning information of the target object includes: performing, based on the location error, location correction on the transverse location information included in the first positioning information, to obtain transverse corrected location information; and determining the location information in the second positioning information of the target object based on the transverse corrected location information and the longitudinal location information included in the first positioning information.

The transverse corrected location information is location information that is obtained through location correction performed, based on the location error, on the transverse location information included in the first positioning information and that belongs to a transverse dimension.

For example, the terminal may perform, based on the location error, location correction on the transverse location information included in the first positioning information, to obtain the transverse corrected location information, and determine the location information in the second positioning information of the target object based on the transverse corrected location information and the longitudinal location information included in the first positioning information. The location information in the second positioning information includes the transverse corrected location information included in the first positioning information and the longitudinal location information included in the first positioning information.

In some embodiments, based on the location error, location correction is performed on the transverse location information included in the first positioning information, to obtain the transverse corrected location information. The location information in the second positioning information of the target object is determined based on the transverse corrected location information and the longitudinal location information included in the first positioning information. In this way, accuracy of the location information in the second positioning information can be further improved, and the waste of the hardware resource configured for supporting positioning of the target object can be further avoided.

In some embodiments, the performing correction on the first positioning information in a first direction based on visual sensor information collected from an environment in which the target object is located, to obtain second positioning information of the target object includes: in a case that satellite positioning information of the target object is received, performing correction on the first positioning information in the first direction based on the visual sensor information collected from the environment in which the target object is located, to obtain corrected positioning information; and performing correction on the corrected positioning information in the second direction based on longitudinal location information in the satellite positioning information, to obtain the second positioning information of the target object.

The satellite positioning information is positioning information provided by a satellite positioning the target object. The satellite positioning information includes the longitudinal location information. The satellite positioning information may further include at least one of transverse location information, velocity information, heading information, and the like.

For example, when the target object is located at a location with a good signal, the terminal arranged on the target object may receive the satellite positioning information obtained through positioning of the target object by the satellite. In a case that the satellite positioning information of the target object is received, the terminal may perform correction on the first positioning information in the first direction based on the visual sensor information collected from the environment in which the target object is located, to obtain the corrected positioning information. Further, correction is performed on the corrected positioning information in the second direction based on the longitudinal location information in the satellite positioning information, to obtain the second positioning information of the target object.

In some embodiments, when the target object is located at a location with a weak signal or without a signal, for example, when the target object is located in a tunnel, the terminal arranged on the target object may not receive the satellite positioning information obtained through positioning of the target object by the satellite. In a case that the satellite positioning information of the target object is not received, the terminal may perform, directly based on the visual sensor information collected from the environment in which the target object is located, correction on the first positioning information obtained through dead reckoning, to obtain the target positioning information after correction and compensation.

In some embodiments, in a case that satellite positioning works, correction is performed on the first positioning information in the first direction based on the visual sensor information collected from the environment in which the target object is located, to obtain the corrected positioning information. Further, correction is performed on the corrected positioning information in the second direction based on the longitudinal location information in the satellite positioning information, to obtain the second positioning information of the target object. In this way, accuracy of the obtained second positioning information can be further improved, and the waste of the hardware resource configured for supporting positioning of the target object can be further avoided.

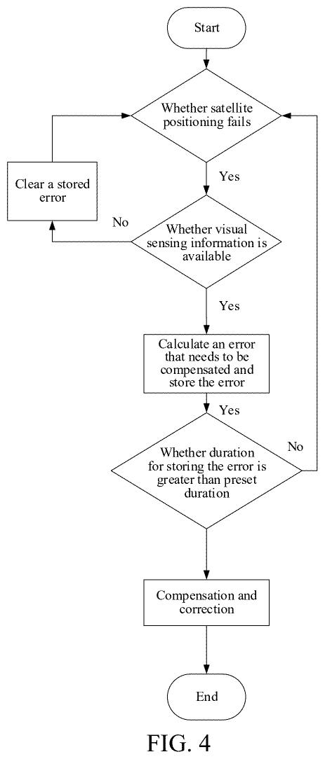

In some embodiments, as shown in FIG. 4, the terminal may determine whether the satellite positioning fails. In a case that the satellite positioning fails, in other words, the satellite positioning information of the target object cannot be received, the terminal may continue to determine whether the visual sensor information is available. In a case that the visual sensor information is unavailable, the terminal may clear the compensation error stored within the current compensation period, and directly use the first positioning information obtained through dead reckoning based on the inertial sensor information of the target object as the target positioning information of the target object. In a case that the visual sensor information is available, correction is performed on the first positioning information in the first direction based on the visual sensor information of the target object, to obtain the second positioning information corresponding to the target object. For the first positioning information calculated at each of the positioning moment within the current compensation period, a distance between the first positioning information and corresponding historical positioning information is determined, to obtain a distance corresponding to each of the positioning moments. For each of the positioning moments within the current compensation period, a compensation sub-error corresponding to the positioning moment is determined based on the distance corresponding to the positioning moment and is stored. Smoothing processing is performed on the compensation sub-error corresponding to each of the positioning moments within the current compensation period (for example, each interval of preset duration is used as a compensation period), to obtain the target compensation error corresponding to the current compensation period. Further, the terminal may perform, based on the target compensation error, correction on the second positioning information corresponding to the target positioning moment in the second direction, to obtain the target positioning information corresponding to the current compensation period.

In some embodiments, the target object includes a target vehicle in a vehicle navigation scenario, the inertial sensor information is collected by using a vehicle inertial sensor arranged on the target vehicle, the visual sensor information is collected by using a vehicle vision sensor arranged on the target vehicle from an environment in which the target vehicle is located, the target positioning information is positioning information of the target vehicle after correction and compensation, and the target positioning information includes vehicle location information; and the method further includes: obtaining an in-vehicle navigation map arranged on the target vehicle; and marking a location of the target vehicle on the in-vehicle navigation map based on the vehicle location information.

For example, first positioning information corresponding to the target vehicle is obtained, and correction is performed on the first positioning information in the first direction based on the visual sensor information of the target vehicle, to obtain second positioning information corresponding to the target vehicle. The terminal may determine a distance between the historical positioning information and the first positioning information, and perform correction on the second positioning information in the second direction based on the distance, to obtain the target positioning information of the target vehicle after correction and compensation. The in-vehicle navigation map arranged on the target vehicle is obtained, and the location of the target vehicle is marked on the in-vehicle navigation map based on the vehicle location information included in the target positioning information after correction and compensation.

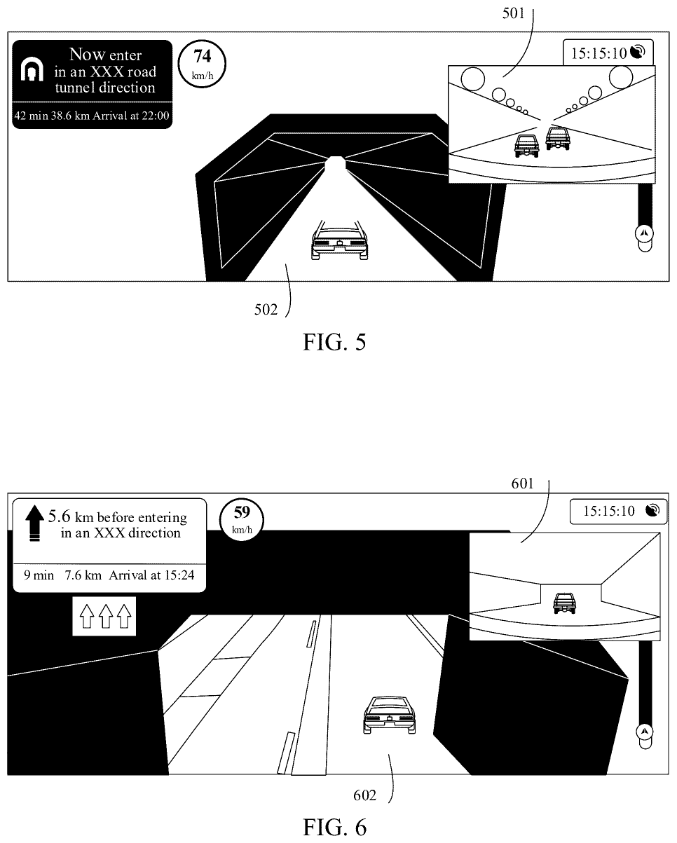

In some embodiments, as shown in FIG. 5, the target vehicle is entering a tunnel, and an image shown in 501 is a real scenario image of a tunnel entrance captured by a camera arranged in the target vehicle. Vehicles shown in 501 are other vehicles that are captured by the camera in the target vehicle, travel in the tunnel, and are located in front of the target vehicle. An image shown in 502 is a virtual image, of the target vehicle itself entering the tunnel, that is rendered and displayed on the in-vehicle navigation map by the terminal, and is configured for showing a user that the target vehicle is entering the tunnel. The terminal may render and display a location of the target vehicle on the in-vehicle navigation map based on the vehicle location information (for example, the corrected vehicle location information of the target vehicle itself) in the positioning information after correction and compensation, so that the user may intuitively see a navigation positioning result of the target vehicle itself.

In some embodiments, as shown in FIG. 6, the target vehicle is exiting the tunnel, and an image shown in 601 is a real scenario image of a tunnel exit captured by the camera arranged in the target vehicle. Vehicles shown in 601 are other vehicles that are captured by the camera in the target vehicle, exit the tunnel, and are located in front of the target vehicle. An image shown in 602 is a virtual image, of the target vehicle itself exiting the tunnel, that is rendered and displayed on the in-vehicle navigation map by the terminal, and is configured for showing the user that the target vehicle is exiting the tunnel. The terminal may render and display the location of the target vehicle on the in-vehicle navigation map based on the vehicle location information in the positioning information after correction and compensation, so that the user may intuitively see the navigation positioning result. By using the positioning information processing method of some embodiments, positioning accuracy for the target vehicle can be improved, so that a positioning result 602 displayed on the in-vehicle navigation map when the target vehicle exits the tunnel may remain consistent with a real location of the target vehicle in the image shown in 601, and the positioning result displayed on the in-vehicle navigation map is prevented from lagging behind the real location of the target vehicle.

In some embodiments, the positioning information processing method of some embodiments is applied to the vehicle navigation scenario. In this way, accuracy of the navigation positioning result of the target vehicle can be improved, and the waste of the hardware resource configured for supporting positioning of the target object can be further avoided.

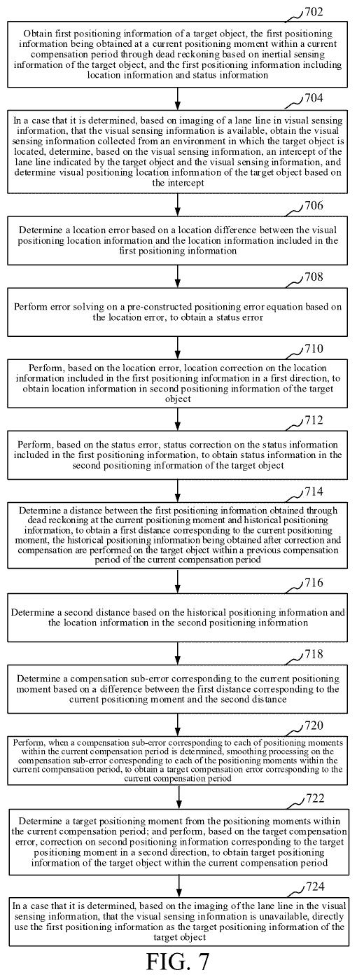

As shown in FIG. 7, in some embodiments, a positioning information processing method is provided. An example in which the method is applied to the terminal 102 in FIG. 1 is used in some embodiments for description, and the method includes the following operations.

Operation 702: Obtain first positioning information of a target object, the first positioning information being obtained at a current positioning moment within a current compensation period through dead reckoning based on inertial sensor information of the target object, and the first positioning information including location information and status information.

Operation 704: In a case that it is determined, based on imaging of a lane line in visual sensor information, that the visual sensor information is available, obtain the visual sensor information collected from an environment in which the target object is located, determine, based on the visual sensor information, an intercept of the lane line indicated by the target object and the visual sensor information, and determine visual positioning location information of the target object based on the intercept.

Operation 706: Determine a location error based on a location difference between the visual positioning location information and the location information included in the first positioning information.

Operation 708: Perform error solving on a pre-constructed positioning error equation based on the location error, to obtain a status error.

In some embodiments, the status error includes at least one of a platform misalignment angle error, a velocity error, a dead reckoning error, a gyro bias, an accelerometer bias, an installation error angle residual, a wheel speed sensor scale factor error, or a time delay of transmission from a wheel speed sensor to an inertial sensor.

Operation 710: Perform, based on the location error, location correction on the location information included in the first positioning information in a first direction, to obtain location information in second positioning information of the target object.

Operation 712: Perform, based on the status error, status correction on the status information included in the first positioning information, to obtain status information in the second positioning information of the target object.

Operation 714: Determine a distance between the first positioning information obtained through dead reckoning at the current positioning moment and historical positioning information, to obtain a first distance corresponding to the current positioning moment, the historical positioning information being obtained after correction and compensation are performed on the target object within a previous compensation period of the current compensation period.

Operation 716: Determine a second distance based on the historical positioning information and the location information in the second positioning information.

Operation 718: Determine a compensation sub-error corresponding to the current positioning moment based on a difference between the first distance corresponding to the current positioning moment and the second distance.

Operation 720: Perform, when a compensation sub-error corresponding to each of positioning moments within the current compensation period is determined, smoothing processing on the compensation sub-error corresponding to each of the positioning moments within the current compensation period, to obtain a target compensation error corresponding to the current compensation period.

Operation 722: Determine a target positioning moment from the positioning moments within the current compensation period; and perform, based on the target compensation error, correction on second positioning information corresponding to the target positioning moment in a second direction, to obtain target positioning information of the target object within the current compensation period.

Operation 724: In a case that it is determined, based on the imaging of the lane line in the visual sensor information, that the visual sensor information is unavailable, directly use the first positioning information as the target positioning information of the target object.

Some embodiments provide an application scenario, and the foregoing positioning information processing method is applied to the application scenario. For example, the positioning information processing method may be applied to a vehicle navigation scenario, for example, the positioning information processing method may be applied to a lane-level vehicle navigation scenario. A terminal may be deployed on a target vehicle. The terminal may obtain first positioning information of the target vehicle, the first positioning information being obtained at a current positioning moment within a current compensation period through dead reckoning based on inertial sensor information of the target vehicle, and the first positioning information including location information and status information; and the inertial sensor information being collected by using a vehicle inertial sensor arranged on the target vehicle.

In a case that it is determined, based on imaging of a lane line in visual sensor information, that the visual sensor information is available, the terminal may obtain the visual sensor information collected from an environment in which the target vehicle is located, determine, based on the visual sensor information, an intercept of the lane line indicated by the target vehicle and the visual sensor information, and determine visual positioning location information of the target vehicle based on the intercept. The visual sensor information is collected by using a vehicle vision sensor arranged on the target vehicle from the environment in which the target vehicle is located. A location error is determined based on a location difference between the visual positioning location information and the location information included in the first positioning information. Error solving is performed on a pre-constructed positioning error equation based on the location error, to obtain a status error. Based on the location error, location correction is performed on the location information included in the first positioning information in a first direction, to obtain location information corresponding to the target vehicle. Based on the status error, status correction is performed on the status information included in the first positioning information, to obtain status information in second positioning information corresponding to the target vehicle.

A distance between the first positioning information obtained through dead reckoning at the current positioning moment and historical positioning information is determined, to obtain a first distance corresponding to the current positioning moment, the historical positioning information being obtained after correction and compensation are performed on the target vehicle within a previous compensation period of the current compensation period. A second distance is determined based on the historical positioning information and location information in the second positioning information. A compensation sub-error corresponding to the current positioning moment is determined based on a difference between the first distance corresponding to the current positioning moment and the second distance. When a compensation sub-error corresponding to each of positioning moments within the current compensation period is determined, smoothing processing is performed on the compensation sub-error corresponding to each of the positioning moments within the current compensation period, to obtain a target compensation error corresponding to the current compensation period. A target positioning moment is determined from the positioning moments within the current compensation period; and based on the target compensation error, correction is performed on second positioning information corresponding to the target positioning moment in a second direction, to obtain positioning information of the target vehicle within the current compensation period after correction and compensation.

In a case that it is determined, based on imaging of a lane line in the visual sensor information, that the visual sensor information is unavailable, the terminal may directly use the first positioning information as the positioning information of the target vehicle after correction and compensation.

Some embodiments provide an application scenario, and the foregoing positioning information processing method is applied to the application scenario. For example, the positioning information processing method may be applied to a scenario for positioning of a driving vehicle in autonomous driving and assisted driving. Autonomous driving and assisted driving may involve positioning of the driving vehicle, to determine a location of the driving vehicle. By using the positioning information processing method in some embodiments, accurate vehicle positioning results may be obtained in an autonomous driving scenario and an assisted driving scenario. The positioning information processing method in some embodiments may be further applied to a positioning scenario for a mobile robot other than a vehicle, or the like. By using the positioning information processing method in some embodiments, an accurate positioning result for the mobile robot may be obtained.

Although the operations in the flowcharts of some embodiments are displayed sequentially according to a sequence, these operations are not necessarily performed sequentially according to the sequence. Unless otherwise indicated, there is no strict sequence limitation on the execution of the operations, and the operations may be performed in another sequence. At least a part of the operations in some embodiments may include a plurality of sub-operations or a plurality of stages. These sub-operations or stages are not necessarily performed and completed at the same positioning moment, and may be performed at different positioning moments. Besides, the sub-operations or stages may not be necessarily performed sequentially, and may be performed in turn or alternately with other operations or at least a part of sub-operations or stages of other operations.

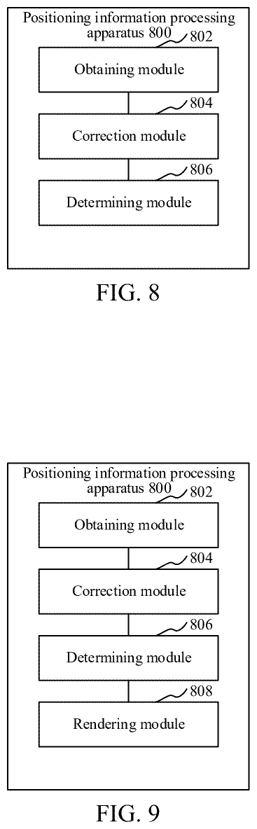

In some embodiments, as shown in FIG. 8, a positioning information processing apparatus 800 is provided. The apparatus may use a software module or a hardware module or a combination of the two as a part of a computer device, and the apparatus includes:
an obtaining module 802, configured to obtain first positioning information of a target object, the first positioning information being obtained through dead reckoning based on inertial sensor information collected for the target object;
a correction module 804, configured to perform correction on the first positioning information in a first direction based on visual sensor information collected from an environment in which the target object is located, to obtain second positioning information of the target object; and
a determining module 806, configured to obtain historical positioning information of the target object, and determine a first distance based on the historical positioning information and the first positioning information, the historical positioning information being obtained after correction and compensation are performed on historically calculated positioning information, and the historically calculated positioning information being obtained through dead reckoning before the first positioning information is obtained through dead reckoning,
the correction module 804 being further configured to perform correction on the second positioning information in a second direction based on the first distance, to obtain target positioning information of the target object after correction and compensation.

In some embodiments, a distance between the historical positioning information and the first positioning information is the first distance; and the correction module 804 is further configured to determine a second distance based on the historical positioning information and the second positioning information; and perform correction on the second positioning information in the second direction based on a difference between the first distance and the second distance, to obtain the target positioning information of the target object after correction and compensation.

In some embodiments, the second positioning information includes transverse positioning information and longitudinal positioning information; and the correction module 804 is further configured to perform longitudinal correction on the longitudinal positioning information based on the difference between the first distance and the second distance, to obtain longitudinal corrected positioning information; and determine, based on the transverse positioning information and the longitudinal corrected positioning information, the target positioning information after correction and compensation.

In some embodiments, the transverse positioning information includes transverse location information, the longitudinal positioning information includes longitudinal location information, the longitudinal corrected positioning information includes longitudinal corrected location information, and the target positioning information includes target location information; and the correction module 804 is further configured to perform longitudinal location correction on the longitudinal location information based on the difference between the first distance and the second distance, to obtain the longitudinal corrected location information; and determine, based on the transverse location information and the longitudinal corrected location information, the target location information after location correction and compensation.

In some embodiments, the first positioning information is positioning information obtained through dead reckoning at a current positioning moment within a current compensation period; the determining module 806 is further configured to determine a distance between the first positioning information obtained through dead reckoning at the current positioning moment and the historical positioning information, to obtain the first distance corresponding to the current positioning moment, where the historical positioning information is obtained after correction and compensation are performed on the target object within a previous compensation period of the current compensation period; and the correction module 804 is further configured to determine a compensation sub-error corresponding to the current positioning moment based on the first distance corresponding to the current positioning moment; perform, when a compensation sub-error corresponding to each of positioning moments within the current compensation period is determined, smoothing processing on the compensation sub-error corresponding to each of the positioning moments within the current compensation period, to obtain a target compensation error corresponding to the current compensation period; determine a target positioning moment from the positioning moments within the current compensation period; and perform, based on the target compensation error, correction on second positioning information corresponding to the target positioning moment in the second direction, to obtain target positioning information of the target object within the current compensation period.

In some embodiments, in a case that it is determined, based on imaging of a lane line in the visual sensor information, that the visual sensor information is available, the correction module 804 is further configured to perform correction on the first positioning information in the first direction based on the visual sensor information collected from the environment in which the target object is located, to obtain the second positioning information of the target object.

In some embodiments, in a case that it is determined, based on imaging of a lane line in the visual sensor information, that the visual sensor information is unavailable, the determining module 806 is further configured to use the first positioning information as the target positioning information of the target object.

In some embodiments, the correction module 804 is further configured to obtain the visual sensor information collected from the environment in which the target object is located, determine, based on the visual sensor information, an intercept of the lane line indicated by the target object and the visual sensor information, and determine visual positioning location information of the target object based on the intercept; determine a compensation error based on the visual positioning location information and the first positioning information; and perform correction on the first positioning information in the first direction based on the compensation error, to obtain the second positioning information of the target object.

In some embodiments, the first positioning information includes location information and status information, the second positioning information includes location information and status information, and the compensation error includes a location error and a status error; and the correction module 804 is further configured to perform, based on the location error, location correction on the location information included in the first positioning information in the first direction, to obtain location information corresponding to the target object; and perform, based on the status error, status correction on the status information included in the first positioning information, to obtain the status information in the second positioning information corresponding to the target object.

In some embodiments, the correction module 804 is further configured to determine the location error based on a location difference between the visual positioning location information and the location information included in the first positioning information; and perform error solving on a pre-constructed positioning error equation based on the location error, to obtain the status error.

In some embodiments, the positioning error equation is a system of positioning error equations, the system of positioning error equations includes a status equation and a measuring equation, and the correction module 804 is further configured to perform error solving on the pre-constructed system of positioning error equations based on the location error, to obtain the status error.

In some embodiments, the status error includes at least one of a platform misalignment angle error, a velocity error, a dead reckoning error, a gyro bias, an accelerometer bias, an installation error angle residual, a wheel speed sensor scale factor error, or a time delay of transmission from a wheel speed sensor to an inertial sensor, the inertial sensor is arranged on the target object, and the inertial sensor information of the target object is collected by using the inertial sensor.

In some embodiments, the location information included in the first positioning information includes transverse location information and longitudinal location information; and the correction module 804 is further configured to perform, based on the location error, location correction on the transverse location information included in the first positioning information, to obtain transverse corrected location information; and determine, based on the transverse corrected location information and the longitudinal location information included in the first positioning information, the location information in the second positioning information corresponding to the target object.

In some embodiments, the correction module 804 is further configured to perform, in a case that satellite positioning information of the target object is received, correction on the first positioning information in the first direction based on the visual sensor information collected from the environment in which the target object is located, to obtain corrected positioning information; and perform correction on the corrected positioning information in the second direction based on longitudinal location information in the satellite positioning information, to obtain the second positioning information of the target object.

In some embodiments, the target object includes a target vehicle in a vehicle navigation scenario, the inertial sensor information is collected by using a vehicle inertial sensor arranged on the target vehicle, the visual sensor information is collected by using a vehicle vision sensor arranged on the target vehicle from an environment in which the target vehicle is located, the target positioning information is positioning information of the target vehicle after correction and compensation, and the target positioning information includes vehicle location information; and as shown in FIG. 9, other than the obtaining module 802, the correction module 804, and the determining module 806, the foregoing positioning information processing apparatus 800 further includes:
a rendering module 808, configured to obtain an in-vehicle navigation map arranged on the target vehicle; and mark a location of the target vehicle on the in-vehicle navigation map based on the vehicle location information.

The foregoing positioning information processing apparatus obtains the first positioning information of the target object, the first positioning information being obtained through dead reckoning based on the inertial sensor information collected for the target object; performs correction on the first positioning information in the first direction based on the visual sensor information collected from the environment in which the target object is located, to obtain the second positioning information of the target object; obtains the historical positioning information of the target object, and determines the first distance based on the historical positioning information and the first positioning information, the historical positioning information being obtained after correction and compensation are performed on the historically calculated positioning information, and the historically calculated positioning information being obtained through dead reckoning before the first positioning information is obtained through dead reckoning; and performs correction on the second positioning information in the second direction based on the first distance. This is equivalent to that, without depending on satellite positioning, both compensation and correction in the first direction and compensation and correction in the second direction are performed on positioning information obtained through dead reckoning. Therefore, the target positioning information finally obtained after correction and compensation is more accurate, and positioning accuracy is improved, so that a waste of a hardware resource configured for supporting positioning of the target object can be avoided.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

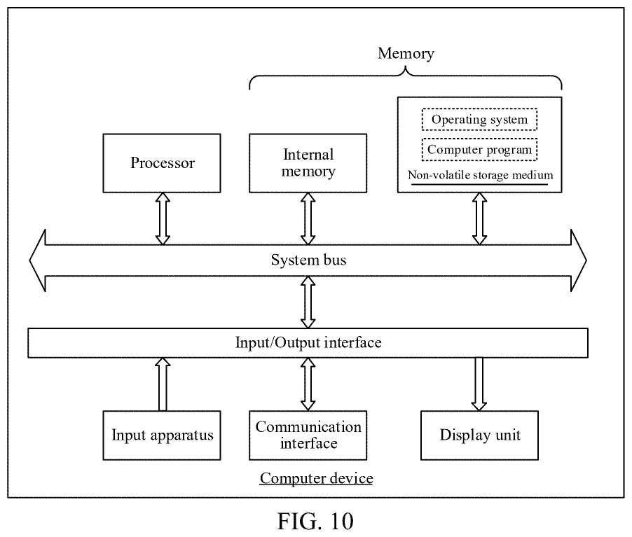

In some embodiments, a computer device is provided. The computer device may be a terminal, and a diagram of an internal structure thereof may be shown in FIG. 10. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium has an operating system and computer-readable instructions stored therein. The internal memory provides an environment for running of the operating system and the computer-readable instructions in the non-volatile storage medium. The input/output interface of the computer device is configured for information exchange between the processor and an external device. The communication interface of the computer device is configured to communicate with an external terminal in a wired or wireless manner. The wireless communication may be implemented by Wi-Fi, a mobile cellular network, near field communication (NFC), or another technology. The computer-readable instructions are executed by the processor to implement a positioning information processing method. The display unit of the computer device is configured to form a visually visible picture, and may be a display screen, a projection apparatus, or a virtual reality imaging apparatus. The display screen may be a liquid crystal display screen or an electronic ink display screen. The input apparatus of the computer device may be a touch layer covering the display screen, or may be a key, a trackball, or a touch pad disposed on a housing of the computer device, or may be an external keyboard, a touch pad, a mouse, or the like.

A person skilled in the art may understand that, the structure shown in FIG. 10 is merely a block diagram of a part of a structure related to some embodiments and does not limit the computer device. For example, the computer device may include more members than those in the drawings, or include a combination of some members, or include different member layouts.

In some embodiments, a computer device is further provided, including a memory and one or more processors, the memory having computer-readable instructions stored therein, and the operations in the foregoing method embodiments being implemented when the processor executes the computer-readable instructions.

In some embodiments, one or more computer-readable storage media are provided, having computer-readable instructions stored therein, and the operations in the foregoing method embodiments being implemented when the computer-readable instructions are executed by one or more processors.

In some embodiments, a computer program product is provided, including computer-readable instructions, and the operations in the foregoing method embodiments being implemented when the computer-readable instructions are executed by one or more processors.

User information (including but not limited to user device information, user personal information, and the like) and data (including but not limited to data configured for analysis, stored data, displayed data, and the like) involved should be authorized by the user or fully authorized by all parties, and the collection, use and processing of relevant data should comply with relevant laws, regulations and standards of relevant countries and regions.

A person of ordinary skill in the art may understand that all or some of the procedures of the methods of some embodiments may be implemented by computer-readable instructions instructing relevant hardware. The computer-readable instructions may be stored in a non-volatile computer-readable storage medium. When the computer-readable instructions are executed, the procedures of some embodiments of the foregoing methods may be included. Any reference to a memory, a storage, a database, or another medium used in some embodiments provided in some embodiments may include at least one of a non-volatile memory and a volatile memory. The non-volatile memory may include a read-only memory (ROM), a magnetic tape, a floppy disk, a flash memory, an optical memory, and the like. The volatile memory may include a random access memory (RAM) or an external cache. For the purpose of description instead of limitation, the RAM is available in a plurality of forms, such as a static random access memory (SRAM) or a dynamic random access memory (DRAM).

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of some embodiments of the disclosure and the appended claims.

What is claimed is:

1. A positioning information processing method, performed by a terminal, comprising:
obtaining first positioning information of a target object through dead reckoning based on inertial sensor information collected for the target object;
obtaining second positioning information of the target object based on performing first correction and compensation on the first positioning information in a first direction based on visual sensor information collected from an environment in which the target object is located;
obtaining historical positioning information of the target object, and determining a first distance based on the historical positioning information and the first positioning information, wherein the historical positioning information is obtained based on performing historical correction and compensation on historically calculated positioning information, and wherein the historically calculated positioning information is obtained through dead reckoning before the first positioning information is obtained through dead reckoning;
obtaining target positioning information of the target object based on performing second correction and compensation on the second positioning information in a second direction based on the first distance; and
outputting via a display, a depiction of the target object at a location on a navigation map that is based on the target positioning information.

2. The positioning information processing method according to claim 1, wherein the obtaining the target positioning information comprises:
determining a second distance based on the historical positioning information and the second positioning information; and
performing the second correction and compensation on the second positioning information in the second direction based on a difference between the first distance and the second distance, to obtain the target positioning information.

3. The positioning information processing method according to claim 2, wherein the second positioning information comprises transverse positioning information and longitudinal positioning information, and wherein the obtaining the target positioning information comprises:
obtaining longitudinal corrected positioning information by performing longitudinal correction and compensation on the longitudinal positioning information based on the difference between the first distance and the second distance; and
determining the target positioning information based on the transverse positioning information and the longitudinal corrected positioning information.

4. The positioning information processing method according to claim 3, wherein the transverse positioning information comprises transverse location information, the longitudinal positioning information comprises longitudinal location information, the longitudinal corrected positioning information comprises longitudinal corrected location information, and the target positioning information comprises target location information,
wherein the obtaining the longitudinal corrected positioning information comprises obtaining the longitudinal corrected location information by performing longitudinal location correction on the longitudinal location information based on the difference between the first distance and the second distance, to obtain the longitudinal corrected location information, and
wherein the determining the target positioning information comprises determining the target location information based on the transverse location information and the longitudinal corrected location information.

5. The positioning information processing method according to claim 1, wherein the first positioning information is obtained through dead reckoning at a current positioning moment within a current compensation period,
wherein the determining the first distance comprises obtaining the first distance by determining a distance between the first positioning information at the current positioning moment and the historical positioning information, wherein the historical positioning information is obtained after target correction and compensation are performed on the target object within a previous compensation period of the current compensation period, and
wherein the obtaining the target positioning information comprises:
determining a compensation sub-error corresponding to the current positioning moment based on the first distance corresponding to the current positioning moment;
based on determining a plurality of compensation sub-errors corresponding to a plurality of positioning moments within the current compensation period, performing smoothing on the plurality of compensation sub-errors, to obtain a target compensation error corresponding to the current compensation period;
determining a first target positioning moment from the plurality of positioning moments; and
performing, based on the target compensation error, the second correction and compensation on second positioning information for the first target positioning moment in the second direction, to obtain first target positioning information of the target object within the current compensation period.

6. The positioning information processing method according to claim 1, further comprising:
determining that the visual sensor information is available based on imaging of a lane line in the visual sensor information, that the visual sensor information is available; and
performing the first correction and compensation on the first positioning information in the first direction based on the visual sensor information, to obtain the second positioning information of the target object.

7. The positioning information processing method according to claim 1, further comprising:
determining that the visual sensor information is unavailable based on imaging of a lane line in the visual sensor information; and
using the first positioning information as the target positioning information.

8. The positioning information processing method according to claim 6, wherein the obtaining the second positioning information of the target object comprises:
obtaining the visual sensor information, determining, based on the visual sensor information, an intercept of the lane line indicated by the target object and the visual sensor information, and determining visual positioning location information of the target object based on the intercept;
determining a compensation error based on the visual positioning location information and the first positioning information; and
performing the first correction and compensation on the first positioning information in the first direction based on the compensation error, to obtain the second positioning information of the target object.

9. The positioning information processing method according to claim 8, wherein the first positioning information comprises first location information and first status information, the second positioning information comprises second location information and second status information, and the compensation error comprises a location error and a status error, and
wherein the obtaining the second positioning information comprises:
performing, based on the location error, location correction on the first location information in the first direction, to obtain the second location information; and
performing, based on the status error, status correction on the first status information, to obtain the second status information.

10. The positioning information processing method according to claim 9, wherein the determining the compensation error comprises:
determining the location error based on a location difference between the visual positioning location information and the first location information; and
performing error solving on a pre-constructed positioning error equation based on the location error, to obtain the status error.

11. A positioning information processing apparatus, comprising:
at least one memory configured to store computer program code; and
at least one processor configured to read the program code and operate as instructed by the program code, the program code comprising:
first positioning code configured to cause at least one of the at least one processor to obtain first positioning information of a target object through dead reckoning based on inertial sensor information collected for the target object;
second positioning code configured to cause at least one of the at least one processor to obtain second positioning information of the target object based on performing first correction and compensation on the first positioning information in a first direction based on visual sensor information collected from an environment in which the target object is located;
historical positioning code configured to cause at least one of the at least one processor to obtain historical positioning information of the target object, and determine a first distance based on the historical positioning information and the first positioning information, wherein the historical positioning information is obtained based on performing historical correction and compensation on historically calculated positioning information, and wherein the historically calculated positioning information is obtained through dead reckoning before the first positioning information is obtained through dead reckoning;
first target positioning code configured to cause at least one of the at least one processor to obtain target positioning information of the target object based on performing second correction and compensation on the second positioning information in a second direction based on the first distance; and
display code configured to cause at least one of the at least one processor to output via a display, a depiction of the target object at a location on a navigation map that is based on the target positioning information.

12. The positioning information processing apparatus according to claim 11, wherein the first target positioning code is configured to cause at least one of the at least one processor to:
determine a second distance based on the historical positioning information and the second positioning information; and
perform the second correction and compensation on the second positioning information in the second direction based on a difference between the first distance and the second distance, to obtain the target positioning information.

13. The positioning information processing apparatus according to claim 12, wherein the second positioning information comprises transverse positioning information and longitudinal positioning information, and wherein the first target positioning code further comprises longitudinal code and second target positioning code,
wherein the longitudinal code is configured to cause at least one of the at least one processor to obtain longitudinal corrected positioning information by performing longitudinal correction and compensation on the longitudinal positioning information based on the difference between the first distance and the second distance, and
wherein the second target positioning code is configured to cause at least one of the at least one processor to determine the target positioning information based on the transverse positioning information and the longitudinal corrected positioning information.

14. The positioning information processing apparatus according to claim 13, wherein the transverse positioning information comprises transverse location information, the longitudinal positioning information comprises longitudinal location information, the longitudinal corrected positioning information comprises longitudinal corrected location information, and the target positioning information comprises target location information;
wherein the longitudinal code is configured to cause at least one of the at least one processor to obtain the longitudinal corrected location information by performing longitudinal location correction on the longitudinal location information based on the difference between the first distance and the second distance, to obtain the longitudinal corrected location information; and
wherein the second target positioning code is configured to cause at least one of the at least one processor to determine the target location information based on the transverse location information and the longitudinal corrected location information.

15. The positioning information processing apparatus according to claim 11, wherein the first positioning information is obtained through dead reckoning at a current positioning moment within a current compensation period,
wherein the historical positioning code is configured to cause at least one of the at least one processor to determine the first distance by determining a distance between the first positioning information at the current positioning moment and the historical positioning information, wherein the historical positioning information is obtained after target correction and compensation are performed on the target object within a previous compensation period of the current compensation period, and
wherein the target positioning code is configured to cause at least one of the at least one processor to:
determine a compensation sub-error corresponding to the current positioning moment based on the first distance corresponding to the current positioning moment;
based on determining a plurality of compensation sub-errors corresponding to a plurality of positioning moments within the current compensation period, perform smoothing on the plurality of compensation sub-errors, to obtain a target compensation error corresponding to the current compensation period;
determine a first target positioning moment from the plurality of positioning moments; and
perform, based on the target compensation error, the second correction and compensation on second positioning information for the first target positioning moment in the second direction, to obtain first target positioning information of the target object within the current compensation period.

16. The positioning information processing apparatus according to claim 11, wherein the program code further comprises lane line code configured to cause at least one of the at least one processor to:
determine that the visual sensor information is available based on imaging of a lane line in the visual sensor information, that the visual sensor information is available; and
perform the first correction and compensation on the first positioning information in the first direction based on the visual sensor information, to obtain the second positioning information of the target object.

17. The positioning information processing apparatus according to claim 11, wherein the program code further comprises lane line code configured to cause at least one of the at least one processor to:
determine that the visual sensor information is unavailable based on imaging of a lane line in the visual sensor information; and
use the first positioning information as the target positioning information.

18. The positioning information processing apparatus according to claim 16, wherein the second positioning code is configured to cause at least one of the at least one processor to:
obtain the visual sensor information, determining, based on the visual sensor information, an intercept of the lane line indicated by the target object and the visual sensor information, and determining visual positioning location information of the target object based on the intercept;
determine a compensation error based on the visual positioning location information and the first positioning information; and
perform the first correction and compensation on the first positioning information in the first direction based on the compensation error, to obtain the second positioning information of the target object.

19. The positioning information processing apparatus according to claim 18, wherein the first positioning information comprises first location information and first status information, the second positioning information comprises second location information and second status information, and the compensation error comprises a location error and a status error, and
wherein the second positioning code is configured to cause at least one of the at least one processor to:
perform, based on the location error, location correction on the first location information in the first direction, to obtain the second location information; and
perform, based on the status error, status correction on the first status information, to obtain the second status information.

20. A non-transitory computer-readable storage media, storing computer code which, when executed by at least one processor, causes the at least one processor to at least:
obtain first positioning information of a target object through dead reckoning based on inertial sensor information collected for the target object;
obtain second positioning information of the target object based on performing first correction and compensation on the first positioning information in a first direction based on visual sensor information collected from an environment in which the target object is located;
obtain historical positioning information of the target object, and determine a first distance based on the historical positioning information and the first positioning information, wherein the historical positioning information is obtained based on performing historical correction and compensation on historically calculated positioning information, and wherein the historically calculated positioning information is obtained through dead reckoning before the first positioning information is obtained through dead reckoning;
obtain target positioning information of the target object based on performing second correction and compensation on the second positioning information in a second direction based on the first distance; and
output via a display, a depiction of the target object at a location on a navigation map that is based on the target positioning information.
